(19) United States
(12) Patent Application Publication
(10) Pub. No.: US 2021/0107027 A1
(43) Pub. Date: Apr. 15, 2021

(54) ATOMIZER AND HUMIDITY CONTROLLER

(71) Applicant: SHARP KABUSHIKI KAISHA, Sakai City, Osaka (JP)

(72) Inventors: SHO OCHI, Sakai City, Osaka (JP); TETSUYA IDE, Sakai City, Osaka (JP); HIROKA HAMADA, Sakai City, Osaka (JP); JUN SAKUMA, Sakai City, Osaka (JP); TSUYOSHI KAMADA, Sakai City, Osaka (JP)

(21) Appl. No.: 17/055,467

(22) PCT Filed: May 15, 2019
(86) PCT No.: PCT/JP2019/019215

§ 371 Date: Nov. 13, 2020

(30) Foreign Application Priority Data
May 15, 2018 (JP) 2018-093787

(51) Int. Cl. B05B 17/06; B01D 53/26; F24F 3/14

(52) U.S. Cl. CPC B05B 17/06; F24F 2110/20; F24F 3/1417; B01D 53/263

(57) ABSTRACT

An atomizer and a humidity controller that are able to separate water with high atomization efficiency are provided. The atomizer includes: a housing that includes an intake port and a discharge port; an ultrasonic wave generating unit that irradiates at least some hygroscopic liquid stored in the housing and containing a hygroscopic substance with ultrasonic waves and generates atomized droplets containing moisture; and an adjustment unit that adjusts relative humidity to reduce a vapor pressure determined in accordance with the relative humidity to less than a saturated vapor pressure of the hygroscopic liquid in at least a portion of a gas-liquid interface in an inner space of the housing.

### TECHNICAL FIELD

The present invention relates to an atomizer and a humidity controller.

This application claims priority based on Japanese Patent Application No. 2018-093787 filed in Japan on May 15, 2018, the content of which is incorporated herein.

### BACKGROUND ART

Conventional desiccant dehumidifiers that use a hygroscopic material include a separating apparatus that heats the hygroscopic material and evaporates and separates water absorbed by the hygroscopic material, thereby recovering hygroscopic performance of the hygroscopic material. However, such a separating apparatus has a state change of water from liquid to gas. Therefore, there is a problem that thermal energy equal to or more than the latent heat of water is required and much power is consumed.

On the other hand, ultrasonic atomizers that include a vibrator for irradiating liquid with ultrasonic waves to atomize the liquid are known. PTL 1 discloses a separating apparatus including an atomizer that ultrasonically vibrates a mixed liquid containing a plurality of components and atomizes the mixed liquid into atomized fine particles, thereby obtaining a mixed fluid of the atomized fine particles and air, a collector that separates the air from the mixed fluid obtained by the atomizer and collects an atomized component, and an outside air heat exchanger that heats a carrier gas to be supplied to a liquid surface of the liquid atomized by the ultrasonic vibration.

PTL 1 describes that the separating apparatus is able to efficiently generate the atomized fine particles with low energy consumption and efficiently separate the mixed liquid. PTL 1 further describes the reason as follows. The separating apparatus atomizes the mixed liquid into the atomized fine particles by using the ultrasonic vibration, collects the atomized fine particles, and separates the mixed liquid into liquids having different component contents, and further efficiently carries out the separation by effectively utilizing thermal energy of the outside air.

Since such an atomizer does not have a state change of water from liquid to gas, it is possible to reduce thermal energy, and power consumption is considered to be reduced.

### CITATION LIST

### Patent Literature

PTL 1: Japanese Unexamined Patent Application Publication No. 2006-051442

### SUMMARY OF INVENTION

### Technical Problem

However, when the atomizer is used for the purpose of separating water from a liquid hygroscopic material, atomization efficiency is not necessarily high.

An aspect of the invention is made in view of the circumstances described above and aims to provide an atomizer and a humidity controller that are able to separate water with high atomization efficiency.

Note that, in the present specification, “atomization amount” means the amount of a reduction of liquid when the liquid is atomized by ultrasonic waves.

In the present specification, “atomization efficiency” means a value obtained by dividing the atomization amount by the amount of power supplied to a vibrator.

### Solution to Problem

As a result of earnest examination, the inventors found that a possible factor of the reduction in the atomization efficiency is as follows. It was revealed that a vapor pressure determined in accordance with relative humidity may be higher than a saturated vapor pressure of liquid (hygroscopic material) in a portion of a gas-liquid interface in an inner space of an atomizer. In this case, moisture in the gas was considered to move to the hygroscopic material to return the saturated vapor pressure of the hygroscopic material and the vapor pressure to an equilibrium state. Accordingly, a possible factor of the reduction in the atomization efficiency was the moisture moving to the hygroscopic material (that is, the hygroscopic material absorbing the moisture). By finding that an atomizer having the following aspects is able to separate water with high atomization efficiency, the inventors completed the invention.

An aspect of the invention provides an atomizer including: a housing that includes an intake port and a discharge port; an ultrasonic wave generating unit that irradiates at least some hygroscopic liquid stored in the housing and containing a hygroscopic substance with ultrasonic waves and generates atomized droplets containing moisture; and an adjustment unit that adjusts relative humidity to reduce a vapor pressure determined in accordance with the relative humidity to less than a saturated vapor pressure of the hygroscopic liquid in at least a portion of a gas-liquid interface in an inner space of the housing.

In an aspect of the invention, the atomizer may have a configuration in which the atomizer further includes a supply channel which is connected to the intake port and through which gas is supplied to the inner space and the adjustment unit includes a cooling and condensing unit that is connected to a portion of the supply channel and that cools the gas and thereby condenses and removes at least some moisture contained in the gas.

In an aspect of the invention, the atomizer may have a configuration in which the atomizer further includes a transport channel that connects the discharge port and a portion of the supply channel and a connection part of the transport channel is arranged on an inflow side of the cooling and condensing unit.

In an aspect of the invention, the atomizer may have a configuration in which the adjustment unit includes a heating unit that heats at least a portion of the gas-liquid interface in the inner space.

In an aspect of the invention, the atomizer may have a configuration in which the heating unit is arranged above the ultrasonic wave generating unit.

In an aspect of the invention, the atomizer may have a configuration in which the atomizer further includes a supply channel which is connected to the intake port and through which gas is supplied to the inner space and the heating unit is provided in a portion of the supply channel.

In an aspect of the invention, the atomizer may have a configuration in which the atomizer further includes a supply channel which is connected to the intake port and through which gas is supplied to the inner space and the adjustment unit includes a cooling and condensing unit that is connected to a portion of the supply channel and that cools the gas and thereby condenses and removes at least some moisture contained in the gas, and the heating unit is provided between the cooling and condensing unit and the intake port.

In an aspect of the invention, the atomizer may have a configuration in which the atomizer further includes a transport channel that connects the discharge port and a portion of the supply channel and a connection part of the transport channel is arranged on an inflow side of the cooling and condensing unit.

An aspect of the invention provides a humidity controller including: a moisture absorption unit that brings hygroscopic liquid and air into contact with each other and thereby causes the hygroscopic liquid to absorb at least some moisture contained in the air; an atomizing and regenerating unit that atomizes and removes at least some moisture contained in the hygroscopic liquid supplied from the moisture absorption unit and thereby regenerates the hygroscopic liquid; and a liquid transport channel that connects the moisture absorption unit and the atomizing and regenerating unit, in which the atomizing and regenerating unit includes the atomizer.

In an aspect of the invention, the humidity controller may have a configuration in which the moisture absorption unit includes a moisture absorption tank storing the hygroscopic liquid, the humidity controller further includes a channel that connects an inner space of the moisture absorption tank and the intake port.

### Advantageous Effects of Invention

According to an aspect of the invention, an atomizer and a humidity controller that are able to separate water with high atomization efficiency are provided.

### BRIEF DESCRIPTION OF DRAWINGS

FIG. 1 is a schematic view illustrating a configuration of an atomizer of a first embodiment.

FIG. 2 is a schematic view illustrating a configuration of a humidity controller 10 of the first embodiment.

FIG. 3 is a schematic view illustrating a configuration of an atomizer of a second embodiment.

FIG. 4 is a schematic view illustrating a configuration of an atomizer of a third embodiment.

FIG. 5 is a schematic view illustrating a heating unit 30A.

FIG. 6 is a schematic view illustrating a heating unit 30B.

FIG. 7 is a schematic view illustrating a configuration of an atomizer of a fourth embodiment.

FIG. 8 is a schematic view illustrating a configuration of an atomizer of a fifth embodiment.

FIG. 9 is a schematic view illustrating a configuration of a humidity controller of a sixth embodiment.

### DESCRIPTION OF EMBODIMENTS

### First Embodiment

[Atomizer]

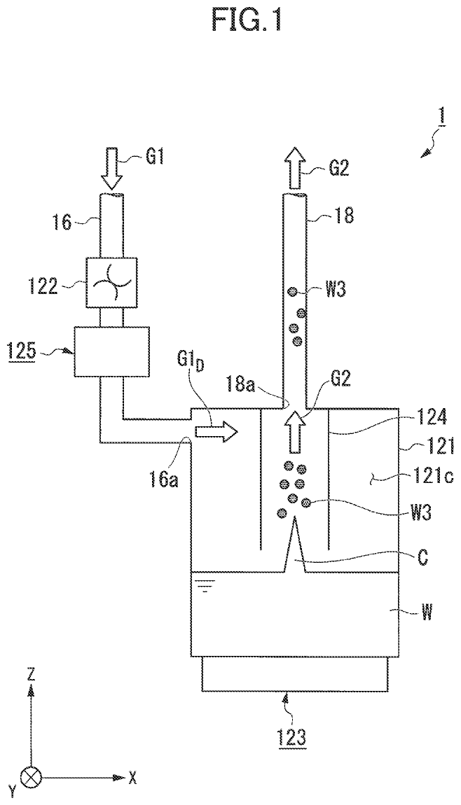

An atomizer of a first embodiment will be described below with reference to FIG. 1.

Note that, in the drawings used in the following description, for the purpose of emphasizing a characteristic portion, the characteristic portion may be enlarged for convenience, and dimensional ratios or the like of components are not necessarily the same as actual ones. In addition, for a similar purpose, a portion that is not characteristic may be omitted in the drawings.

In a three-dimensional orthogonal coordinate system (XYZ coordinate system) appropriately illustrated in each of the drawings, the Z-axis direction is defined as the up-down direction. The X-axis direction and the Y-axis direction are each directions in a horizontal direction orthogonal to the Z-axis direction and are orthogonal to each other.

FIG. 1 is a schematic view illustrating a configuration of the atomizer of the first embodiment. As illustrated in FIG. 1, an atomizer 1 includes an atomizing and regenerating tank 121, a blower 122, an ultrasonic wave generating unit 123, a guiding pipe 124, a cooling and condensing unit 125, a supply channel 16, and a discharge channel 18.

In the present specification, “regenerating” means separating moisture from hygroscopic liquid and recovering moisture absorbing performance of the hygroscopic liquid.

In the present specification, the atomizing and regenerating tank 121 corresponds to “housing” in the claims.

In the present specification, the cooling and condensing unit 125 corresponds to “adjustment unit” in the claims.

The atomizing and regenerating tank 121 has an inner space 121c. The atomizing and regenerating tank 121 stores hygroscopic liquid W in the inner space 121c. The hygroscopic liquid W will be described later. An intake port 16a and a discharge port 18a are provided above a liquid surface of the hygroscopic liquid W in the atomizing and regenerating tank 121. The intake port 16a is provided on the side surface of the atomizing and regenerating tank 121. The discharge port 18a is provided on the upper surface of the atomizing and regenerating tank 121.

(Supply Channel)

The supply channel 16 has one end connected to the intake port 16a. On the other hand, the supply channel 16 has the other end connected to a supply source (not illustrated) of gas G1. The gas G1 is supplied from the supply source to the supply channel 16 by using the blower 122 described later.

The gas G1 is not particularly limited and may be, for example, air or an inert gas.

(Cooling and Condensing Unit)

The cooling and condensing unit 125 is connected to the middle of the supply channel 16. The cooling and condensing unit 125 cools the gas G1 and thereby condenses and removes at least some moisture contained in the gas G1.

The cooling and condensing unit 125 includes a cooling device. Examples of the cooling device include a Peltier element. When the atomizer 1 is installed in an outdoor unit of an air conditioner, a heat exchanger used in a heating operation may be used as the cooling device. Thereby, energy consumption of the atomizer 1 is lowered.

(Blower)

The blower 122 supplies gas G1_{D} whose moisture has been removed to a gas-liquid interface in the inner space 121c of the atomizing and regenerating tank 121. The gas G1_{D} forms an air current which flows from the intake port 16a to the discharge port 18a.

(Ultrasonic Wave Generating Unit)

The ultrasonic wave generating unit 123 irradiates some of the hygroscopic liquid W containing moisture with ultrasonic waves and generates, from the hygroscopic liquid W, atomized droplets W3 that contain moisture. The atomized droplets W3 preferably have a diameter in a range of not less than 1 nanometer and less than 1 μm.

The ultrasonic wave generating unit 123 is in contact with the outer bottom surface (surface in the −Z direction) of the atomizing and regenerating tank 121. Note that a position at which the ultrasonic wave generating unit 123 is installed is not particularly limited as long as the atomized droplets W3 are able to be generated from the hygroscopic liquid W.

The ultrasonic wave generating unit 123 includes one vibrator. Note that the number of vibrators of the ultrasonic wave generating unit 123 may be two or more.

When the ultrasonic wave generating unit 123 irradiates the hygroscopic liquid W with the ultrasonic waves, a liquid column C of the hygroscopic liquid W may be generated on the liquid surface of the hygroscopic liquid W. The liquid column C generates numerous atomized droplets W3 described above.

The ultrasonic wave generating unit 123 is able to control the generation amount and diameter of the atomized droplets W3 by controlling an irradiation condition of the ultrasonic waves. Specifically, examples of the irradiation condition of the ultrasonic waves include ultrasonic wave frequency and power supplied to the ultrasonic wave generating unit 123.

The ultrasonic wave frequency is preferably in a range of 1.0 MHz or more and 5.0 MHz or less, for example. When the ultrasonic wave frequency is within the range, the generation amount of the atomized droplets W3 is able to be increased. When the ultrasonic wave frequency is 1.0 MHz or more, the diameter of the atomized droplets W3 is able to be in the range of not less than 1 nanometer and less than 1 μm.

The power supplied to the ultrasonic wave generating unit 123 is preferably, for example, 2 W or more and more preferably 10 W or more per vibrator. When the power supplied to the ultrasonic wave generating unit 123 is 2 W or more, the liquid column C of the hygroscopic liquid W is formed due to wave pressure, and therefore, the hygroscopic liquid W is easily atomized. As a result, it is possible to increase the generation amount of the atomized droplets W3.

A humidity controller 10 is able to control the generation amount of the atomized droplets W3 also by controlling a distance from the surface of the ultrasonic wave generating unit 123 to the liquid surface of the hygroscopic liquid W.

A distance from the bottom surface of the atomizing and regenerating tank 121 to the liquid surface of the hygroscopic liquid W is preferably in a range of 1 cm or more and 6 cm or less. When the distance is 1 cm or more, the risk of irradiation in the absence of hygroscopic liquid W is low, and it is possible to sufficiently increase the generation amount of the atomized droplets W3. When the distance is 6 cm or less, the liquid column C of the hygroscopic liquid W is easily generated. As a result, it is possible to efficiently generate the atomized droplets W3.

(Discharge Channel)

The discharge channel 18 has one end connected to the discharge port 18a. On the other hand, the discharge channel 18 has the other end arranged outside the atomizing and regenerating tank 121.

When the atomizer 1 is viewed from above (the +Z direction), the ultrasonic wave generating unit 123 and the discharge port 18a overlap each other in plan view. Since the ultrasonic wave generating unit 123 and the discharge port 18a have such a positional relationship, the liquid column C is generated at a position where the liquid column C and the discharge port 18a overlap each other in plan view when the atomizer 1 is viewed from above.

(Guiding Pipe)

The guiding pipe 124 is used to guide, to the discharge port 18a, the atomized droplets W3 generated from the hygroscopic liquid W. When the humidity controller 10 is viewed from above, the guiding pipe 124 surrounds the discharge port 18a in plan view.

With such a positional relationship between the ultrasonic wave generating unit 123, the guiding pipe 124, and the discharge port 18a, the guiding pipe 124 surrounds the liquid column C in the atomizer 1. Thereby, an air current which flows upward from the liquid surface of the hygroscopic liquid W conveys, to the discharge port 18a, the atomized droplets W3 generated from the liquid column C.

(Hygroscopic Liquid)

The hygroscopic liquid W of the present embodiment is a liquid that exhibits hygroscopicity and is preferably a liquid that exhibits hygroscopicity at a temperature of 25° C. and a relative humidity of 50% and under atmospheric conditions.

The hygroscopic liquid W of the present embodiment contains a hygroscopic substance. The hygroscopic liquid W of the present embodiment may contain a hygroscopic substance and a solvent. As the solvent, a solvent that dissolves the hygroscopic substance or that is mixable with the hygroscopic substance is used, and examples thereof include water.

The hygroscopic substance may be an organic material or an inorganic material.

Examples of the organic material used as the hygroscopic substance include a dihydric or higher alcohol, a ketone, an organic solvent having an amide group, a saccharide, and a known material used as a raw material for moisturizing cosmetics etc.

Among these, from the viewpoint of high hydrophilicity, the dihydric or higher alcohol, the organic solvent having the amide group, the saccharide, or the known material used as the raw material for moisturizing cosmetics etc. is preferable as the organic material used as the hygroscopic substance.

Examples of the dihydric or higher alcohol include glycerin, propanediol, butanediol, pentanediol, trimethylolpropane, butanetriol, ethylene glycol, diethylene glycol, and triethylene glycol.

Examples of the organic solvent having the amide group include formamide and acetamide.

Examples of the saccharide include sucrose, pullulan, glucose, xylol, fructose, mannitol, and sorbitol.

Examples of the known material used as the raw material for moisturizing cosmetics etc. include 2-methacryloyloxyethyl phosphorylcholine (MPC), betaine, hyaluronic acid, and collagen.

Examples of the inorganic material used as the hygroscopic substance include calcium chloride, lithium chloride, magnesium chloride, potassium chloride, sodium chloride, zinc chloride, aluminum chloride, lithium bromide, calcium bromide, potassium bromide, sodium hydroxide, and sodium pyrrolidone carboxylate.

In a case where hydrophilicity of the hygroscopic substance is high, when, for example, the material as described above is mixed with water, a high proportion of water molecules exist in the vicinity of the surface (liquid surface) of the hygroscopic liquid W. The atomizer 1 generates the atomized droplets W3 in the vicinity of the surface of the hygroscopic liquid W to separate moisture from hygroscopic liquid W2. Thus, when the proportion of the water molecules in the vicinity of the surface of the hygroscopic liquid W is high, the moisture is able to be efficiently separated.

Moreover, a relatively low proportion of the hygroscopic substance exists in the vicinity of the surface of the hygroscopic liquid W. Therefore, the atomizer 1 is able to reduce leakage of the hygroscopic substance.

The concentration of the hygroscopic substance relative to the total mass of the hygroscopic liquid W is not particularly limited but is preferably 40 mass % or more.

Viscosity of the hygroscopic liquid W of the present embodiment is preferably 100 mPa-s or less and more preferably 50 mPa-s or less at a temperature of 20° C. Thereby, the liquid column C of the hygroscopic liquid W is easily generated on the liquid surface of the hygroscopic liquid W. Thus, the moisture is able to be efficiently separated from the hygroscopic liquid W. Moreover, the viscosity of the hygroscopic liquid W of the present embodiment may be, for example, 1 mPa's or more at a temperature of 20° C.

As a result of earnest examination, the inventors found that a vapor pressure determined in accordance with relative humidity may be higher than a saturated vapor pressure of the hygroscopic liquid in at least a portion of a gas-liquid interface (that is, an interface between gas and the hygroscopic liquid) in the inner space 121c of the atomizing and regenerating tank 121. In this case, moisture in the gas was considered to move to the hygroscopic liquid W (that is, the hygroscopic liquid W was considered to absorb the moisture) to return the saturated vapor pressure of the hygroscopic liquid W and the vapor pressure to an equilibrium state.

In the present specification, the atomization amount of the hygroscopic liquid W when the moisture absorption amount of the hygroscopic liquid W is estimated to be zero is defined as “theoretical atomization amount”. The atomization amount of the hygroscopic liquid W is obtained as a difference between the theoretical atomization amount of the hygroscopic liquid W and the moisture absorption amount of the hygroscopic liquid W. Thus, reducing the moisture absorption amount of the hygroscopic liquid W is considered for increasing the atomization amount of the hygroscopic liquid W with respect to the amount of power supplied to the vibrator of the ultrasonic wave generating unit 123.

Through examination, the inventors found that the moisture absorption amount of the hygroscopic liquid W was able to be reduced by reducing the vapor pressure determined in accordance with the relative humidity to less than the saturated vapor pressure of the hygroscopic liquid in at least a portion of the gas-liquid interface in the inner space 121c of the atomizing and regenerating tank 121. Reducing the moisture amount of the gas supplied to the gas-liquid interface is considered to achieve the reduction.

As described above, the cooling and condensing unit 125 cools the gas G1 and thereby condenses and removes at least some of the moisture contained in the gas G1. Thereby, the cooling and condensing unit 125 adjusts the relative humidity to reduce the vapor pressure determined in accordance with the relative humidity to less than the saturated vapor pressure of the hygroscopic liquid in at least a portion of the gas-liquid interface in the inner space 121c of the atomizing and regenerating tank 121. By adjusting the relative humidity in this manner, the moisture absorption amount of the hygroscopic liquid W is lowered, resulting in the atomization amount of the hygroscopic liquid W being able to be increased.

(Operating Principle)

An operating principle of the atomizer 1 will be described below.

The atomizer 1 drives the ultrasonic wave generating unit 123 to irradiate some of the hygroscopic liquid W with the ultrasonic waves and generate the atomized droplets W3 from the hygroscopic liquid W. Separately, the atomizer 1 drives an external device for supplying the gas G1 and supplies the gas G1 to the supply channel 16.

Next, the atomizer 1 cools the gas G1 by using the cooling and condensing unit 125 and thereby condenses and removes at least some of the moisture contained in the gas G1. The atomizer 1 drives the blower 122 to supply the gas G1_{D} whose moisture has been removed to the gas-liquid interface in the inner space 121c of the atomizing and regenerating tank 121. The vapor pressure determined in accordance with the relative humidity becomes less than the saturated vapor pressure of the hygroscopic liquid in the gas-liquid interface to which the gas G1_{D} is supplied. Thereby, the moisture absorption amount of the hygroscopic liquid W is lowered, resulting in the atomization amount of the hygroscopic liquid W being able to be increased.

The air current which flows from the intake port 16a to the discharge port 18a is formed in the inner space 121c of the atomizing and regenerating tank 121. The air current causes the gas G2 that contains the atomized droplets W3 to be discharged from the discharge port 18a of the atomizing and regenerating tank 121 to air A2 outside the atomizing and regenerating tank 121.

The atomizer 1 is able to separate water with high atomization efficiency.

[Humidity Controller]

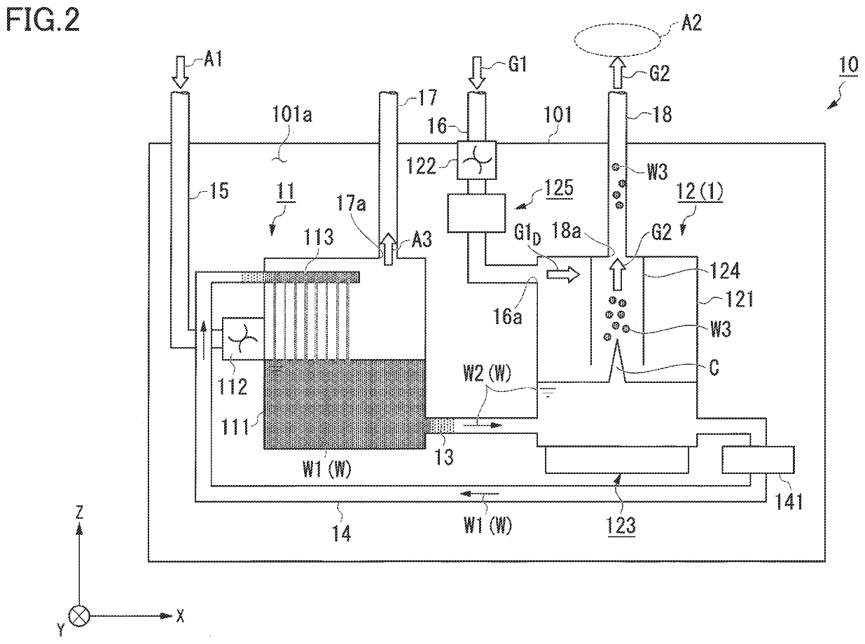

The humidity controller that includes the atomizer 1 described above will be described below with reference to FIG. 2. FIG. 2 is a schematic view illustrating a configuration of the humidity controller 10 of the first embodiment. As illustrated in FIG. 2, the humidity controller 10 of the present embodiment includes a housing 101, a moisture absorption unit 11, an atomizing and regenerating unit 12, a first liquid transport channel 13, and a second liquid transport channel 14. The atomizing and regenerating unit 12 includes the atomizer 1.

The housing 101 of the present embodiment has an inner space 101a. The housing 101 of the present embodiment stores at least the moisture absorption unit 11 and the atomizing and regenerating unit 12 in the inner space 101a.

The moisture absorption unit 11 and the atomizing and regenerating unit 12 have the hygroscopic liquid W stored therein.

In the following description, the liquid used for treatment by the moisture absorption unit 11 is referred to as “hygroscopic liquid W1”. The liquid treated by the atomizing and regenerating unit 12 is referred to as “hygroscopic liquid W2”. Note that a configuration formed by combining the hygroscopic liquid W1 and the hygroscopic liquid W2 is referred to as “hygroscopic liquid W”.

Moreover, in the following description, the air to be treated by the moisture absorption unit 11 is referred to as “air A1”. The air discharged from the moisture absorption unit 11 is referred to as “air A3”. The air to be mixed with the gas G2 discharged from the atomizing and regenerating unit 12 is referred to as “air A2”.

The hygroscopic liquid W is transported through the first liquid transport channel 13 and the second liquid transport channel 14. The hygroscopic liquid W is transported from the moisture absorption unit 11 to the atomizing and regenerating unit 12 through the first liquid transport channel 13. The hygroscopic liquid W is transported from the atomizing and regenerating unit 12 to the moisture absorption unit 11 through the second liquid transport channel 14. A pump 141 by which the hygroscopic liquid W is circulated is connected to the middle of the second liquid transport channel 14.

The inner space of the moisture absorption unit 11 and the outside of the housing 101 communicate with each other via an air supply channel 15. The air A1 is supplied from outside the housing 101 to the inner space of the moisture absorption unit 11 through the air supply channel 15.

The inner space of the moisture absorption unit 11 and the outside of the housing 101 communicate with each other via an air discharge channel 17. The air A3 is discharged from the inner space of the moisture absorption unit 11 to outside the housing 101 through the air discharge channel 17.

(Moisture Absorption Unit)

The moisture absorption unit 11 sends the air A1 from outside the housing 101 to the inner space of the moisture absorption unit 11, brings the air A1 and the hygroscopic liquid W1 in the inner space into contact with each other, and causes the hygroscopic liquid W1 to absorb moisture contained in the air A1. The moisture absorption unit 11 includes a moisture absorption tank 111, a blower 112, a nozzle part 113, the air supply channel 15, and the air discharge channel 17.

The moisture absorption tank 111 stores the hygroscopic liquid W1. The blower 112 and the air discharge channel 17 are connected to an upper portion of the moisture absorption tank 111. The second liquid transport channel 14 is connected to the moisture absorption tank 111 at a portion above a liquid surface of the hygroscopic liquid W1. The first liquid transport channel 13 is connected to the moisture absorption tank 111 at a portion below the liquid surface of the hygroscopic liquid W1.

The air supply channel 15 has one end connected to the blower 112. On the other hand, the air supply channel 15 has the other end arranged outside the housing 101.

The blower 112 supplies the air A1 to the inner space of the moisture absorption tank 111 via the air supply channel 15. The air A1 sent by the blower 112 forms an air current which flows from the blower 112 to a discharge port 17a of the air discharge channel 17.

The nozzle part 113 causes the hygroscopic liquid W1 to flow downward in the direction of gravity in a substantially columnar form in the inner space of the moisture absorption tank 111. At this time, the air current of the air A1 is generated by the blower 112 in the inner space of the moisture absorption tank 111, and thus the air A1 is able to come into contact with the hygroscopic liquid W1. In this manner, the moisture contained in the air A1 is absorbed by the hygroscopic liquid W1. As described above, the concentration of the hygroscopic substance in the hygroscopic liquid W is preferably 40 mass % or more. Thereby, the moisture absorption unit 11 is able to cause the hygroscopic liquid W1 to efficiently absorb the moisture.

A system for bringing the air A1 into contact with the hygroscopic liquid W1 in the present embodiment is typically called a flow-down system. The nozzle part 113 is arranged above the liquid surface of the hygroscopic liquid W1 stored in the moisture absorption tank 111. The nozzle part 113 is connected to the other end of the second liquid transport channel 14.

As described above, even when the viscosity of the hygroscopic liquid W takes a high value near 100 mPa's at a temperature of 20° C., the moisture absorption unit 11 is able to efficiently bring the hygroscopic liquid W into contact with the air A1.

The air A3 obtained by the moisture absorption unit 11 is obtained by removing the moisture from the air A1 and is thus drier than the air A1.

On the other hand, the gas G2 obtained by the atomizing and regenerating unit 12 contains the generated atomized droplets W3 and is thus more humid than the air A2 outside the housing 101.

(Operating Principle)

An operating principle of the humidity controller 10 will be described below. Note that the operating principle of the atomizing and regenerating unit 12 is as described above.

The moisture absorption unit 11 drives the blower 112 to supply the air A1 from outside the housing 101 to the inner space of the moisture absorption tank 111. At this time, the air current of the air A1 is formed in the inner space of the moisture absorption tank 111. On the other hand, the hygroscopic liquid W1 regenerated by the atomizing and regenerating unit 12 is reused by the pump 141 from the atomizing and regenerating tank 121 to the moisture absorption tank 111 and flows downward from the nozzle part 113 in the inner space of the moisture absorption tank 111 due to gravity. Thereby, the hygroscopic liquid W1 is brought into contact with the air A1 and is caused to absorb the moisture contained in the air A1. The air A3 obtained by removing the moisture from the air A1 is discharged to outside the housing 101 from the discharge port 17a of the moisture absorption tank 111.

When the humidity controller 10 is applied to an air conditioner, the air A1 is in one space (for example, indoors) and the air A2 is in another space (for example, outdoors). When the humidity controller 10 is used as a dehumidifier, the air A1 and the air A2 are in the same space, but the atomized droplets W3 contained in the gas G2 may be collected by a collecting unit that may be provided in the discharge channel 18.

The humidity controller 10 includes the atomizer 1 described above. Thus, the humidity controller 10 is able to regenerate the hygroscopic liquid with low energy.

### Second Embodiment

[Atomizer]

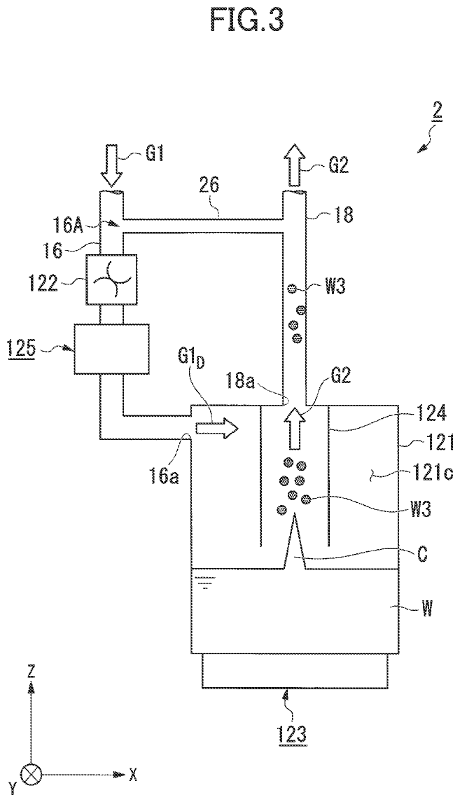

An atomizer of a second embodiment will be described below with reference to FIG. 3. FIG. 3 is a schematic view illustrating a configuration of the atomizer of the second embodiment. As illustrated in FIG. 3, an atomizer 2 is partially the same as the atomizer 1 of the first embodiment and differs from the atomizer 1 in that the atomizer 2 includes a transport channel 26. Accordingly, components of the present embodiment equivalent to the components of the first embodiment will be given the same reference numerals, and detailed description thereof will be omitted.

The supply channel 16 and the discharge channel 18 are connected by the transport channel 26. A connection part 16A between the supply channel 16 and the transport channel 26 is provided on an inflow side (+Z side) of the cooling and condensing unit 125.

The gas G2 containing the atomized droplets W3 is transported to the discharge channel 18, the transport channel 26, and the supply channel 16 in this order. The transported gas G2 flows into the cooling and condensing unit 125, has moisture removed by the cooling and condensing unit 125, and results in the gas G1_{D}. The gas G1_{D} is supplied again by the blower 122 to the gas-liquid interface in the inner space 121c of the atomizing and regenerating tank 121.

The atomizer 2 is able to separate water with high atomization efficiency.

### Third Embodiment

[Atomizer]

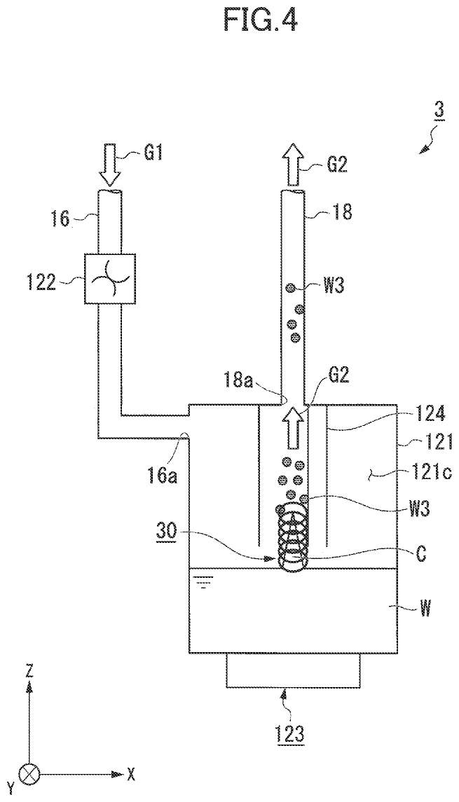

An atomizer of a third embodiment will be described below with reference to FIG. 4. FIG. 4 is a schematic view illustrating a configuration of the atomizer of the third embodiment. As illustrated in FIG. 4, an atomizer 3 is partially the same as the atomizer 1 of the first embodiment and differs from the atomizer 1 in that the atomizer 3 does not include the cooling and condensing unit 125 but includes a heating unit 30. Accordingly, components of the present embodiment equivalent to the components of the first embodiment will be given the same reference numerals, and detailed description thereof will be omitted.

In the present specification, the heating unit 30 corresponds to “adjustment unit” in the claims.

According to the examination by the inventors, increasing the temperature of the gas-liquid interface is considered for reducing the vapor pressure determined in accordance with the relative humidity to less than the saturated vapor pressure of the hygroscopic liquid in at least a portion of the gas-liquid interface in the inner space 121c of the atomizing and regenerating tank 121.

The heating unit 30 heats at least a portion of the gas-liquid interface in the inner space 121c of the atomizing and regenerating tank 121. In FIG. 4, the heating unit 30 includes a coil heater.

The heating unit 30 is arranged above (in the +Z direction of) the ultrasonic wave generating unit 123. That is, when the atomizer 3 is viewed from above, the ultrasonic wave generating unit 123 and the heating unit 30 overlap each other in plan view.

Since the ultrasonic wave generating unit 123 and the heating unit 30 have such a positional relationship, the heating unit 30 is able to efficiently heat the periphery of the liquid column C, which generates numerous atomized droplets. Thereby, the heating unit 30 adjusts the relative humidity to reduce the vapor pressure determined in accordance with the relative humidity to less than the saturated vapor pressure of the hygroscopic liquid in the gas-liquid interface of the liquid column C. Then, the moisture absorption amount of the hygroscopic liquid W is able to be lowered, resulting in the atomization amount of the hygroscopic liquid W being able to be increased.

Note that a position at which the heating unit 30 is installed is not limited to the aforementioned position. The position at which the heating unit 30 is installed is not particularly limited as long as the heating unit 30 is able to heat at least a portion of the gas-liquid interface in the inner space 121c of the atomizing and regenerating tank 121.

Moreover, the heating unit 30 may include a heater other than the coil heater. For example, the heating unit 30 may include an infrared heater.

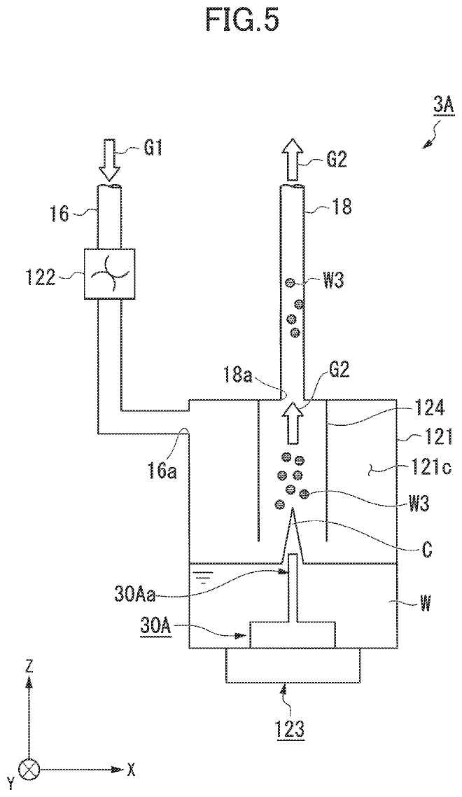

FIG. 5 is a schematic view illustrating a heating unit 30A. The heating unit 30A illustrated in FIG. 5 includes a sheathed heater. At least a portion of the heating unit 30A is arranged below the liquid surface of the hygroscopic liquid W2 stored in the atomizing and regenerating tank 121 in the inner space 121c of the atomizing and regenerating tank 121.

An end 30Aa of the sheathed heater of the heating unit 30A is arranged above (in the +Z direction of) the ultrasonic wave generating unit 123 and the sheathed heater extends upward (in the +Z direction) from the bottom of the atomizing and regenerating tank 121. That is, when an atomizer 3A is viewed from above, the ultrasonic wave generating unit 123 and the end 30Aa of the sheathed heater overlap each other in plan view.

Since the ultrasonic wave generating unit 123 and the end 30Aa of the sheathed heater have such a positional relationship, the heating unit 30A is able to directly heat the liquid column C that generates numerous atomized droplets. Thereby, the heating unit 30A adjusts the relative humidity to reduce the vapor pressure determined in accordance with the relative humidity to less than the saturated vapor pressure of the hygroscopic liquid in the gas-liquid interface of the liquid column C. Then, the moisture absorption amount of the hygroscopic liquid W is able to be lowered, resulting in the atomization amount of the hygroscopic liquid W being able to be increased.

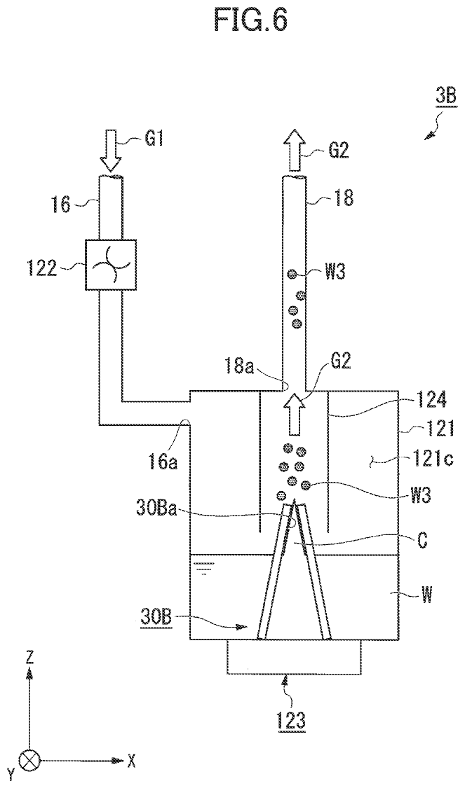

FIG. 6 is a schematic view illustrating a heating unit 30B. The heating unit 30B illustrated in FIG. 6 includes a nozzle capable of heating. At least a portion of the heating unit 30B is arranged below the liquid surface of the hygroscopic liquid W2 stored in the atomizing and regenerating tank 121 in the inner space 121c of the atomizing and regenerating tank 121.

An opening 30Ba of the nozzle of the heating unit 30B is arranged above (in the +Z direction of) the ultrasonic wave generating unit 123. That is, when an atomizer 3B is viewed from above, the ultrasonic wave generating unit 123 and the opening 30Ba of the nozzle overlap each other in plan view. Thereby, the liquid column C is formed so as to pass through the opening 30Ba of the nozzle.

Since the ultrasonic wave generating unit 123 and the opening 30Ba of the nozzle have such a positional relationship, the heating unit 30B is able to directly heat the liquid column C that generates numerous atomized droplets. Thereby, the heating unit 30B adjusts the relative humidity to reduce the vapor pressure determined in accordance with the relative humidity to less than the saturated vapor pressure of the hygroscopic liquid in the gas-liquid interface of the liquid column C. Then, the moisture absorption amount of the hygroscopic liquid W is able to be lowered, resulting in the atomization amount of the hygroscopic liquid W being able to be increased.

The atomizer 3 is able to separate water with high atomization efficiency.

### Fourth Embodiment

[Atomizer]

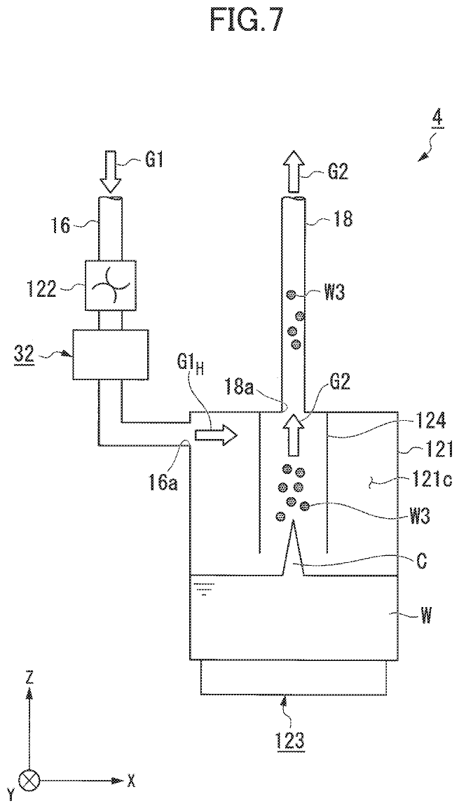

An atomizer of a fourth embodiment will be described below with reference to FIG. 7. FIG. 7 is a schematic view illustrating a configuration of the atomizer of the fourth embodiment. As illustrated in FIG. 7, an atomizer 4 is partially the same as the atomizer 3 of the third embodiment and differs from the atomizer 3 in that a heating unit 32 is provided in a portion of the supply channel 16. Accordingly, components of the present embodiment equivalent to the components of the third embodiment will be given the same reference numerals, and detailed description thereof will be omitted.

The heating unit 32 is provided in a portion of the supply channel 16. The heating unit 32 heats the gas G1 that flows in the supply channel 16. Gas G1_{H} that is heated is supplied by the blower 122 to the gas-liquid interface in the inner space 121c of the atomizing and regenerating tank 121. Thereby, at least a portion of the gas-liquid interface in the inner space 121c of the atomizing and regenerating tank 121 is heated.

The heating unit 32 includes a heating device. Examples of the heating device include a heater. The heating device may be a heat exchanger that uses heat generated by the vibrator of the ultrasonic wave generating unit 123. Further, when the atomizer 4 is used for the humidity controller described above, the heating device may be a heat exchanger that uses heat generated in moisture absorption of the hygroscopic liquid. Further, when the atomizer 4 is installed in an outdoor unit of an air conditioner, a heat exchanger used in a cooling operation may be used as the heating device. By using such a heat exchanger as the heating device, energy consumption of the atomizer 4 is able to be reduced.

The atomizer 4 of the fourth embodiment is able to separate water with high atomization efficiency.

### Fifth Embodiment

[Atomizer]

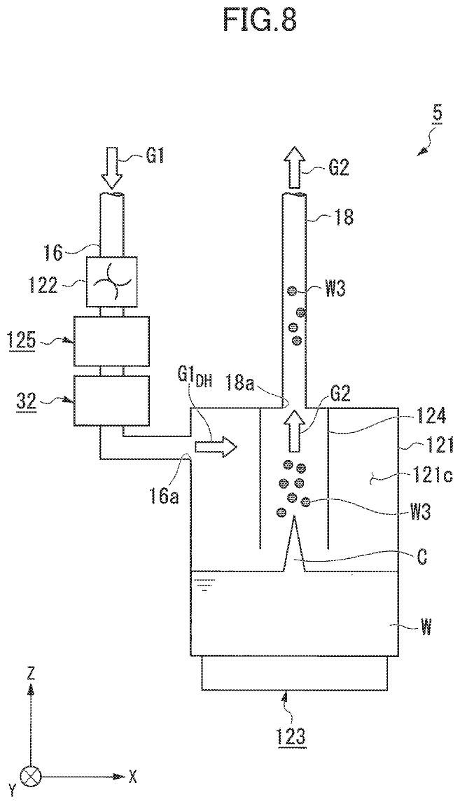

An atomizer of the fourth embodiment will be described below with reference to FIG. 8. FIG. 8 is a schematic view illustrating a configuration of the atomizer of a fifth embodiment. As illustrated in FIG. 8, an atomizer 5 is a combination of the atomizer 1 (refer to FIG. 1) of the first embodiment and the atomizer 4 of the fourth embodiment. Accordingly, components of the present embodiment equivalent to the components of the first embodiment or the fourth embodiment will be given the same reference numerals, and detailed description thereof will be omitted.

The heating unit 32 is provided between the cooling and condensing unit 125 and the intake port 16a. Since the heating unit 32, the cooling and condensing unit 125, and the intake port 16a have such a positional relationship, the heating unit 32 is able to heat gas obtained by the cooling and condensing unit 125 removing the moisture from the gas G1. Thereby, it is possible to increase the temperature of the gas-liquid interface while reducing the moisture amount of gas G1_{DH} supplied to the gas-liquid interface.

Compared with the atomizer 1 of the first embodiment and the atomizer 4 of the fourth embodiment, the atomizer 5 as described above is able to reduce the vapor pressure determined in accordance with the relative humidity to much less than the saturated vapor pressure of the hygroscopic liquid in at least a portion of the gas-liquid interface in the inner space 121c of the atomizing and regenerating tank 121. Thereby, the moisture absorption amount of the hygroscopic liquid W is lowered, resulting in the atomization amount of the hygroscopic liquid W being able to be further increased.

Note that the atomizer 5 may include the transport channel 26 (refer to FIG. 3) of the second embodiment.

The atomizer 5 of the fifth embodiment is able to separate water with high atomization efficiency.

### Sixth Embodiment

[Humidity Controller]

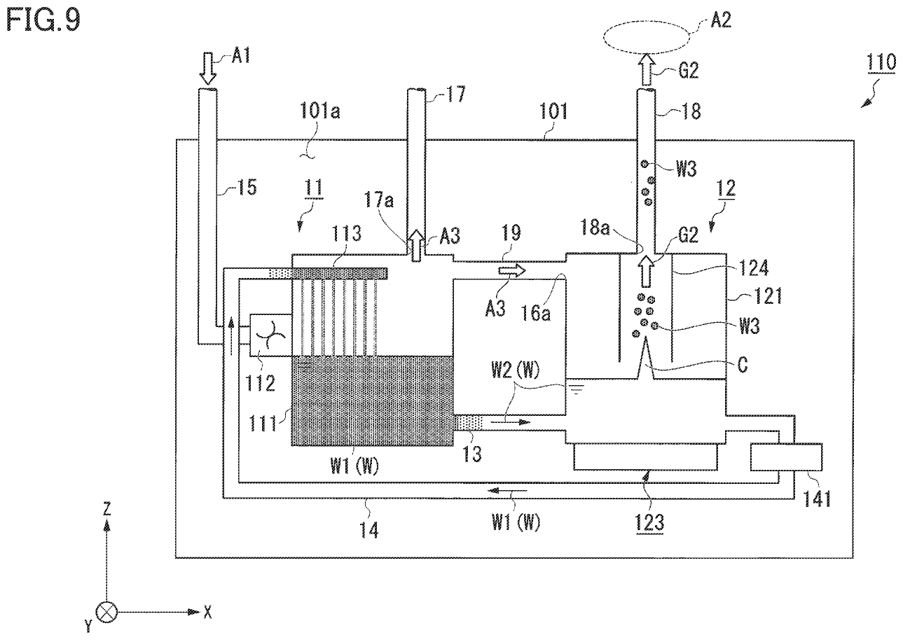

A humidity controller of a sixth embodiment will be described below with reference to FIG. 9. FIG. 9 is a schematic view illustrating a configuration of the humidity controller of the sixth embodiment. As illustrated in FIG. 9, a humidity controller 110 is partially the same as the humidity controller 10 of the first embodiment and differs from the humidity controller 10 in that the humidity controller 110 includes a channel 19 instead of the supply channel 16. Accordingly, components of the present embodiment equivalent to the components of the first embodiment will be given the same reference numerals, and detailed description thereof will be omitted.

The inner space of the moisture absorption tank 111 and the intake port 16a of the atomizing and regenerating tank 121 are connected by the channel 19. Thereby, the air A3 whose moisture has been removed is able to be supplied to the gas-liquid interface in the inner space 121c of the atomizing and regenerating tank 121.

In the gas-liquid interface to which the air A3 is supplied, the vapor pressure determined in accordance with the relative humidity is less than the saturated vapor pressure of the hygroscopic liquid. Thereby, the moisture absorption amount of the hygroscopic liquid W is lowered, resulting in the atomization amount of the hygroscopic liquid W being able to be increased.

The humidity controller 110 includes the atomizer 1 described above. Therefore, the humidity controller 10 is able to regenerate the hygroscopic liquid with low energy.

In particular, the humidity controller 110 reduces the vapor pressure determined in accordance with the relative humidity of the gas-liquid interface to less than the saturated vapor pressure of the hygroscopic liquid by using the air A3 obtained by the moisture absorption unit 11. Thus, the number of components constituting the humidity controller 110 is less than the number of components in the humidity controller 10 of the first embodiment.

Although the embodiments of the invention have been described above, the configurations, combinations thereof, and the like in the embodiments are merely examples, and additions, omissions, substitutions, and other modifications of the configurations are possible without departing from the spirit of the invention. Also, the invention is not limited by the embodiments.

The atomizer of each of the embodiments described above may include a suction means provided in the discharge channel 18 instead of including the blower 122. The suction means is able to make a pressure in the inner space 121c of the atomizing and regenerating tank 121 negative, introduce the gas G1 into the inner space 121c via the intake port 16a, and form an air current of the gas G1.

The atomizer of each of the embodiments described above may not include a guiding pipe. In this case, the discharge port 18a may be provided on the side surface of the atomizing and regenerating tank 121.

In the humidity controller of each of the embodiments described above, the atomizing and regenerating unit 12 may include any of the atomizers 2 to 5 described above. Such a humidity controller is also able to regenerate the hygroscopic liquid with low energy.

In particular, when the humidity controller including the atomizer 2 is used as a dehumidifier, the cooling and condensing unit 125 functions as a collecting unit that collects the atomized droplets W3 in the gas G2. Therefore, the atomizer 2 does not need to additionally have a collecting unit provided in the discharge channel 18. Accordingly, the number of components constituting the humidity controller is reduced.

In the humidity controller of each of the embodiments described above, a contact system of the air is not limited to the flow-down system.

The contact system of the air may be a so-called stand-still system in which the hygroscopic liquid W1 stands still in the air current of the air A1.

The contact system of the air may be a so-called spray system in which the hygroscopic liquid W1 in an atomized state is sprayed in the air current of the air A1.

The contact system of the air may be a so-called bubbling system in which bubbles of the air A1 are brought into contact with the hygroscopic liquid W1.

The contact system of the air may be a system in which the hygroscopic liquid W is caused to flow down through a column or honeycomb structure in the air current of the air A1 such that the hygroscopic liquid W penetrates the column or honeycomb structure.

1. An atomizer comprising:
a housing that includes an intake port and a discharge port;
an ultrasonic wave generating unit that irradiates at least some hygroscopic liquid stored in the housing and containing a hygroscopic substance with ultrasonic waves and generates atomized droplets containing moisture; and
an adjustment unit that adjusts relative humidity to reduce a vapor pressure determined in accordance with the relative humidity to less than a saturated vapor pressure of the hygroscopic liquid in at least a portion of a gas-liquid interface in an inner space of the housing.

2. The atomizer according to claim 1, further comprising
a supply channel which is connected to the intake port and through which gas is supplied to the inner space, wherein
the adjustment unit includes a cooling and condensing unit that is connected to a portion of the supply channel and that cools the gas and thereby condenses and removes at least some moisture contained in the gas.

3. The atomizer according to claim 2, further comprising
a transport channel that connects the discharge port and a portion of the supply channel, wherein
a connection part of the transport channel is arranged on an inflow side of the cooling and condensing unit.

4. The atomizer according to claim 1, wherein the adjustment unit includes a heating unit that heats at least a portion of the gas-liquid interface in the inner space.

5. The atomizer according to claim 4, wherein the heating unit is arranged above the ultrasonic wave generating unit.

6. The atomizer according to claim 4, further comprising
a supply channel which is connected to the intake port and through which gas is supplied to the inner space, wherein
the heating unit is provided in a portion of the supply channel.

7. The atomizer according to claim 4, further comprising
a supply channel which is connected to the intake port and through which gas is supplied to the inner space, wherein
the adjustment unit includes a cooling and condensing unit that is connected to a portion of the supply channel and that cools the gas and thereby condenses and removes at least some moisture contained in the gas, and
the heating unit is provided between the cooling and condensing unit and the intake port.

8. The atomizer according to claim 7, further comprising
a transport channel that connects the discharge port and a portion of the supply channel, wherein
a connection part of the transport channel is arranged on an inflow side of the cooling and condensing unit.

9. A humidity controller comprising:
a moisture absorption unit that brings hygroscopic liquid and air into contact with each other and thereby causes the hygroscopic liquid to absorb at least some moisture contained in the air;
an atomizing and regenerating unit that atomizes and removes at least some moisture contained in the hygroscopic liquid supplied from the moisture absorption unit and thereby regenerates the hygroscopic liquid; and
a liquid transport channel that connects the moisture absorption unit and the atomizing and regenerating unit, wherein
the atomizing and regenerating unit includes the atomizer according to claim 1.

10. The humidity controller according to claim 9,
the moisture absorption unit comprising a moisture absorption tank storing the hygroscopic liquid,
the humidity controller further comprising a channel that connects an inner space of the moisture absorption tank and the intake port.
